(19) United States
(12) Patent Application Publication
(10) Pub. No.: US 2026/0291787 A1
(43) Pub. Date: Sep. 24, 2026

(54) TOMLINSON-HARASHIMA PRECODING ADAPTATION FOR CHANNEL EQUALIZATION

(71) Applicant: QUALCOMM Incorporated, San Diego, CA (US)

(72) Inventors: Aviv REGEV, Tel Aviv (IL); Michael LEVITSKY, Rehovot (IL); Ronen SHAKED, Kfar Saba (IL); Tom BARAK, Rehovot (IL); Amit MOSES, Tel Aviv (IL)

(21) Appl. No.: 19/085,928

(22) Filed: Mar. 20, 2025

(51) Int. Cl. H04L 25/497; H04W 8/22; H04W 52/52

(52) U.S. Cl. CPC H04L 25/4975; H04W 8/22; H04W 52/52

(57) ABSTRACT

Certain aspects of the present disclosure provide techniques for channel equalization. An example method includes sending a first indication of a capability of the UE to use decentralized Tomlinson-Harashima Precoding (dTHP), receiving a configuration to use at least one of: centralized Tomlinson-Harashima Precoding (cTHP) to receive one or more first transmissions via one or more first resources; the dTHP to receive the one or more first transmissions via the one or more first resources; or the dTHP to receive one or more second transmissions via one or more second resources that are different than the one or more first resources.

### INTRODUCTION

### Field of the Disclosure

Aspects of the present disclosure relate to wireless communications, and more particularly, to techniques for channel equalization.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes sending a first indication of a capability of the UE to use decentralized Tomlinson-Harashima Precoding (dTHP); and receiving a configuration to use at least one of: centralized Tomlinson-Harashima Precoding (cTHP) to receive one or more first transmissions via one or more first resources; the dTHP to receive the one or more first transmissions via the one or more first resources; or the dTHP to receive one or more second transmissions via one or more second resources that are different than the one or more first resources.

Certain aspects provide a method for wireless communications by a network entity. The method includes receiving a first indication of a capability of a UE to use dTHP; and sending, to the UE, a configuration to use at least one of: cTHP to receive one or more first transmissions via one or more first resources; the dTHP to receive the one or more first transmissions via the one or more first resources; or the dTHP to receive one or more second transmissions via one or more second resources that are different than the one or more first resources.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment.

FIGS. 4A, 4B, 4C, and 4D depict various example aspects of data structures for a wireless communications network.

FIG. 5 depicts two example Tomlinson-Harashima precoding structures that may be used for channel equalization at a transmitter.

FIG. 6 depicts a process flow for communications in a network between a network entity and a user equipment for adapting a Tomlinson-Harashima precoding operation used for transmission equalization.

FIG. 7 depicts a method for wireless communications.

FIG. 8 depicts another method for wireless communications.

FIG. 9 depicts aspects of an example communications device.

FIG. 10 depicts aspects of an example communications device.

### DETAILED DESCRIPTION

Aspects of the present disclosure provide apparatuses, methods, processing systems, and computer-readable mediums for channel equalization operation adaptation. For example, in certain aspects, a transmitter and a receiver may dynamically switch between the performance of Tomlinson-Harashima precoding (THP) using a centralized THP (cTHP) structure (simply referred to herein as “using” cTHP) and THP precoding using a decentralized THP (dTHP) structure (simply referred to herein as “using” dTHP) for transmission (TX) equalization.

In certain wireless communications systems (e.g., an Evolved Universal Terrestrial Radio Access (E-UTRA) system, 5G New Radio (NR) system, and/or any future wireless communication system), a user equipment (UE) may communicate with a network entity via downlink communications and/or uplink communications. Information communicated between the UE and the network entity (e.g., either via downlink or uplink communication) may be represented as a sequence of binary bits (e.g., the smallest unit of information on a machine, also commonly referred to as “information bits”). For transmission, the binary bits may be mapped (e.g., modulated) to analog signal waveforms and transmitted over a wireless communications channel (e.g., such as a physical downlink shared channel (PDSCH) between the network entity and the UE).

In certain aspects, the transmitted signal may be altered due to non-ideal channel characteristics (e.g., such as fading, multipath propagation, and/or interference) associated with the wireless communications channel used to transmit the signal. Alteration of the original shape and/or one or more characteristics of the transmitted signal (e.g. the transmitted waveform) as it travels through the wireless communications channel may be referred to as “channel distortion.” Channel distortion may may lead to problems that degrade the quality and/or reliability of the transmitted signal.

Channel equalization is one example technique that may be used to mitigate the effects of channel distortion. Specifically, “channel equalization,” refers to a signal processing technique that is used to compensate for signal distortion incurred by a signal as it passes through a wireless communications channel, such that the original data (e.g., information bits of the transmitted signal) can be recovered accurately.

For downlink communications, channel equalization may be performed at a UE (e.g., a receiver of the transmitted signal). Channel equalization performed by a UE for downlink communications may be referred to as “receiver (RX) equalization.” In certain aspects, a UE may perform RX equalization during demodulation, which is a process used to retrieve original data (e.g., information bits) from a modulated carrier wave. For example, a UE may receive a (distorted) signal from a network entity and perform channel estimation to estimate the characteristics of a wireless communications channel that was used for transmission of the signal. Estimation of the channel's characteristic may help the UE to determine how the channel affected the signal during transmission. The UE may use the estimated channel characteristics during channel equalization to undo any distortion(s) to the signal that were caused by the channel, effectively “reversing” the effects of the channel on the received signal. In certain aspects, RX equalization may help to remove inter-symbol interference (ISI) and/or inter-carrier interference (ICI) from the received signal. After RX equalization, the UE may perform demodulation and decoding to recover the original information bits sent to the UE.

One example channel equalization operation, which may be used for RX equalization at the UE, includes minimum mean square error (MMSE) equalization. In association with performing MMSE equalization, a UE may compute an equalizer coefficient for every frequency-domain/time-domain (FD/TD) resource (e.g., every resource element) in a given slot. The UE may then apply each equalizer coefficient in association with performing RX equalization for each FD/TD resource. An “equalizer coefficient” may represent a weight or a parameter of an MMSE equalizer (e.g., a linear filter) that is designed to minimize the mean squared error (MSE) between a received signal and a signal after MMSE equalization is performed.

While channel equalization, such as MMSE equalization, may be useful to mitigate the effects of channel distortion, such as to improve the quality and/or reliability of a transmitted signal, the performance of RX equalization at the UE may result in an undesirable increase in power consumption and complexity at the UE. For example, when MMSE equalization is used, calculating an equalizer coefficient for multiple FD/TD resources may result in the UE performing a large number of calculations (e.g., one calculation per resource), which may significantly increase power consumption at the UE. Moreover, the calculation of an equalizer coefficient may involve multiple operations, such as matrix inversion and matrix multiplication, which makes this calculation even more costly in terms of power consumption and complexity at the UE. Additionally, in certain aspects, a UE employing multiple-input-multiple-output (MIMO) technology, may use multiple antenna elements to simultaneously receive multiple streams of data (e.g., multiple layers), such as to help improve data rates and/or transmission reliability. The multiple receive antennas at the UE may affect dimensions of a channel matrix (H) associated with performing RX equalization and, therefore, increase a number of equalizer coefficients that need to be calculated by the UE, further increasing power consumption and complexity at the UE.

A technical solution to the aforementioned technical problems associated with performing RX equalization (e.g., such as at a UE for downlink communications) may involve shifting the channel equalization performance burden and complexity to a transmitter. For example, instead of a UE performing RX equalization for downlink communications, a network entity may perform transmitter (TX) equalization (also commonly referred to as “TX pre-equalization”) to “pre-distort” a signal prior to transmission to compensate for (e.g., anticipatorily counteract) alteration(s) that the signal may encounter during transmission (e.g., due to channel distortion). In certain aspects, this may involve the network entity performing, based on information obtained for a downlink wireless communications channel, a pre-equalization process on a signal to be transmitted to the UE to obtain a pre-equalized signal, and transmitting the pre-equalized signal to the UE through the downlink channel. By applying the pre-equalization process at the network entity instead of at the UE, equalization-related complexity and power consumption at the UE may be reduced, thereby allowing a simpler hardware design for the UE while maintaining the user experience. For example, utilizing channel equalization techniques at a transmitter (e.g., TX equalization at a network entity) may allow for downlink communication between the network entity and a low complexity or battery-limited device, such as an extended reality (XR) device (e.g., XR glasses), an internet-of-things (IoT) device, and/or reduced capability (RedCap) device, among others, such as in scenarios where power and complexity saving is essential to improve the communication reliability. Beneficially, a simpler hardware design means that wireless capabilities can be more compact, more power efficient, and incorporated into a wider range of devices.

In certain aspects, a transmitter (e.g., a network entity for downlink communications) may utilize channel inversion-based linear precoding techniques, such as MMSE precoding (e.g., an MMSE equalization operation), for TX equalization. For example, prior to transmission, the transmitter may precode a data stream with a TX MMSE precoder to produce a roughly inverse channel response used to cancel the channel distortion at a receiver (e.g., at a UE). While attractive for TX equalization due to its simplicity, channel inversion-based linear precoding techniques may require a higher average transmit power than other precoding algorithms, which may result in a reduced bit error ratio (BER) performance (e.g., BER is the number of bit errors divided by the total number of transferred bits during a time period). Further, in certain aspects, the required higher average transmit power may present a technical challenge for performing TX equalization at a transmitter, at least due to power constraints at the transmitter. For example, the transmitter may not be able to fully compensate a deep fading by increasing the signal's power, thereby leading to burdening the receiver with performing scaling factor multiplication (e.g., to multiply by and enhance the noise level). As an illustrative example, for an FD/TD resource, a wireless communications channel may be attenuating a signal by −20 decibels (dB) (e.g., “deep fading”). Put differently, the signal when received, without the use of TX equalization, may be equal to 0.1*the transmitted signal. To compensate this attenuation (e.g., caused by the channel), a transmitter (e.g., performing TX equalization) may need to multiply the transmitted signal by 10 prior to the transmission. The received signal, when TX equalization is used, may then be 10*0.1*the transmitted signal, which is equal to the transmitted signal, thereby canceling the channel distortion. A technical problem arises in this situation when the transmitter is limited by one or more power constraints. For example, a maximum amplifying factor of the transmitter may be equal to 5; thus, in this example, the transmitter may not be able to fully compensate the deep fading when using MMSE precoding for TX equalization.

To overcome the shortcomings of using MMSE precoding, in some cases, THP (e.g., a non-linear precoding TX equalization technique) may be used in its place. THP is a practical and approximated implementation of the “dirty paper coding (DPC)” that is optimized to achieve a maximum capacity of information over a wireless communications channel. Its principle involves a known interference (e.g., spatial inter-layer or multipath related ISI) pre-cancellation at the transmitter (e.g., on the TX side) using a feedback filter, followed by a feedforward filter for channel pre-equalization. The possible power boosting that may be caused by the feedback filter may be limited with a module applied at the transmitter, with a corresponding module at the receiver (e.g., on the RX side). For example, non-linear components at both the transmitter and receiver, such as two-dimensional (2D)-module blocks, may be used to help ensure compliance with power constraints, and thus avoid burdening the receiver with performing scaling factor multiplication (e.g., as when using MMSE precoding).

Two basic THP structures that may be used for TX equalization include centralized THP (cTHP) and decentralized THP (dTHP), which are defined according to the position of their respective diagonal weighted filters (e.g., matrices) (also referred to herein as “scaling filter G” or “scaling matrix G”). For example, three filters used to implement THP may include (1) a feedback filter B, (2) a feedforward filter F, and (3) a scaling filter G. The scaling filter G may include a weighted coefficient for each data stream (e.g., associated with each transmit antenna at the transmitter or each receive antenna at a receiver, where the transmitter and receiver implement MIMO technologies) and thus, may have a diagonal structure. The dTHP structure may employ scaling filter G (or sub-matrices of it) at a receiver (e.g., such that the filter is “decentralized), while the cTHP structure may use scaling filter G at the transmitter (e.g., such that the filter is “centralized”).

THP using the cTHP structure (referred to herein as “using cTHP”) may involve precoding a transmit signal using the scaling filter G. For example, the scaling filter G may be multiplied with the transmit signal to scale the power of the signal sent from each transmit antenna at the transmitter. In some cases, depending on the values included in scaling filter G, the transmission power of the signal sent from each of the transmitter's antennas may be different across the transmit antennas (e.g., one antenna may transmit with higher power than another antenna). In some cases, this variation in transmission power (e.g., resulting when using the cTHP structure) may lead to one or more performance issues, such as interference between antennas, reduced transmission efficiency, low signal-to-noise ratio (SNR), etc., thereby degrading transmission performance. However, an upside to using cTHP, includes the ability to achieve equal receive power across receive antennas at a receiver of the signal. As such, the receiver may only need to perform a simple automatic gain control (AGC) operation (e.g., one AGC operations for all receive antennas) and decode the received signal (e.g., saving power and time).

As used herein, “AGC” refers to a technique used in wireless communication systems to adjust the amplifier gain (e.g., amplification) of an incoming signal. In certain aspects, a receiver may perform AGC to normalize a received signal (e.g., adjust the received signal strength (e.g., received power)) to a certain desired power suitable for best performance at the receiver.

Alternatively, THP using the dTHP structure (referred to herein as “using dTHP”) may involve applying the scaling filter G to the received signal at the receiver (e.g., as opposed to at the transmitter in cTHP). Application of the scaling filter G to the received signal may adjust the power level of the received signal at each of the receive antennas of the receiver and thereby compensate for any impairments to the received signal due to the channel (e.g., non-ideal conditions of the channel). Thus, in this approach, the signal may be transmitted (e.g., from the transmitter to the receiver) with equal power across transmit antennas of the transmitter. However, the signal may be provided to the receiver with different receive power across the different receive antennas. Accordingly, transmission performance may be improved, but at the cost of the receiver needing to perform an AGC operation for each receive antenna separately. Performing AGC per receive antenna may necessitate increased power consumption and complexity at the receiver.

Per above, using cTHP for TX equalization of a signal beneficially allows for the transmission of the signal to a lower complexity receiver, yet at the cost of degraded transmission performance. Alternatively, using dTHP for TX equalization of a signal beneficially improves transmission performance, but at the cost of increased power consumption and complexity at a receiver of the transmitted signal. In some situations, sacrificing receiver complexity to improve transmission performance may be warranted, while in some other situations, sacrificing transmission performance may be warranted for the communication with a lower complexity receiver. Thus, an ability to adapt the type of non-linear precoding technique that is used, such as between the use of cTHP and dTHP, for TX equalization is desirable.

Certain aspects described herein provide signaling mechanisms that enable a transmitter and a receiver to adapt a type of channel equalization operation used for channel distortion mitigation. More specifically, the signaling mechanisms described herein may enable a transmitter and a receiver to dynamically switch between the use of cTHP and dTHP for TX equalization as needed, such as for different situations. For example, dynamically switching between the use of cTHP and dTHP for TX equalization may be based on different transmitter-receiver pair requirements, with respect to transmission performance and/or receiver complexity, in different situations.

In certain aspects, the signaling mechanisms described herein may enable a receiver to send an indication of a capability of the receiver to use dTHP. For example, in certain aspects, a receiver may indicate, to a transmitter, its ability to support the use of dTHP. In certain other aspects, a receiver may indicate, to a transmitter, its inability to support the use of dTHP, such as based on the receiver indicating its ability to support only the use of cTHP. A receiver capable of supporting dTHP may be a receiver that is capable of performing AGC for each receive antenna of the receiver (e.g., the receiver is a “more complex” receiver designed with advanced capabilities and/or features to perform this AGC per receive antenna).

In certain aspects, the transmitter may configure the receiver to use cTHP only, dTHP only, or both cTHP and dTHP (e.g., for different resources) to receive signal(s) transmitted from the receiver. In certain aspects, the configuration to use cTHP and/or dTHP may be based on the indication of the capability of the receive to use dTHP.

Certain techniques for channel equalization operation adaptation, and more specifically THP adaptation, described herein may provide various beneficial technical effects and/or advantages. For example, in certain aspects where a receiver supports the use of dTHP, the transmitter and receiver may beneficially use dTHP for TX equalization to achieve improved transmission performance, thereby capitalizing on the increased complexity and thus AGC performance capability of the receiver. As another example, in certain aspects where a receiver does not support the use of dTHP (e.g., the receiver is a lower complexity device), the transmitter and receiver may use cTHP for TX equalization, such as to enable the devices to communicate with one another while continuing to mitigate the effects of channel distortion. Further, in some examples, the use of such signaling mechanisms described herein may enable a transmitter to flexibly choose the suitable THP method for TX equalization in different situations, such that receiver complexity may be prioritized in some situations while transmission performance is prioritized in other situations.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

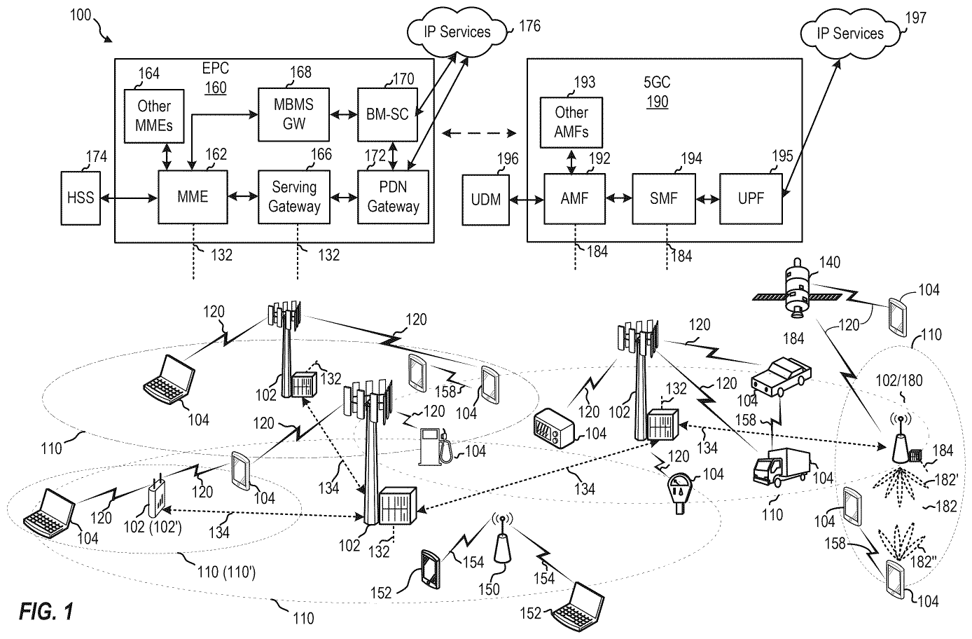

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

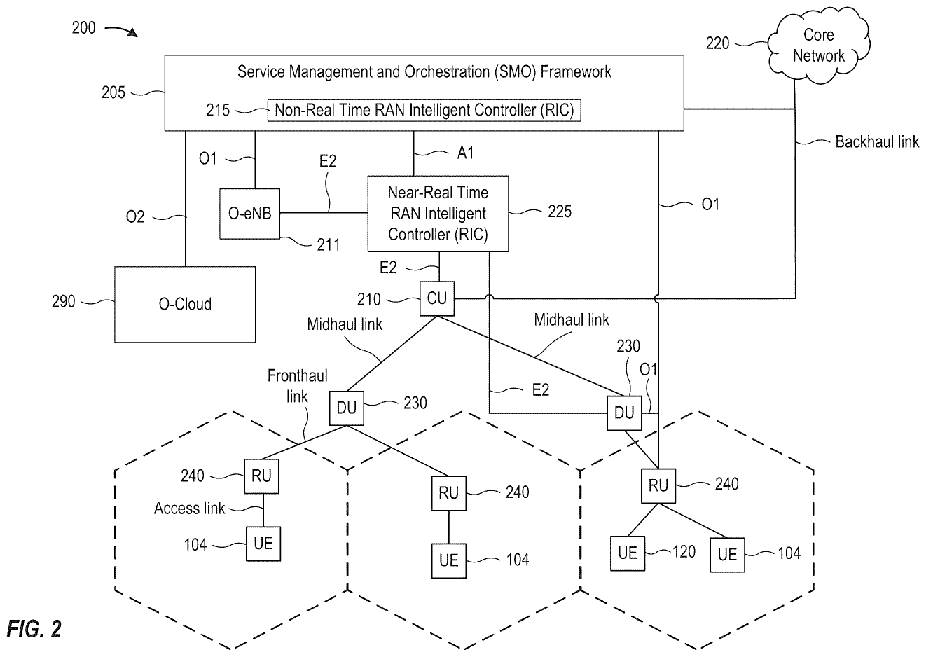

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communications link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

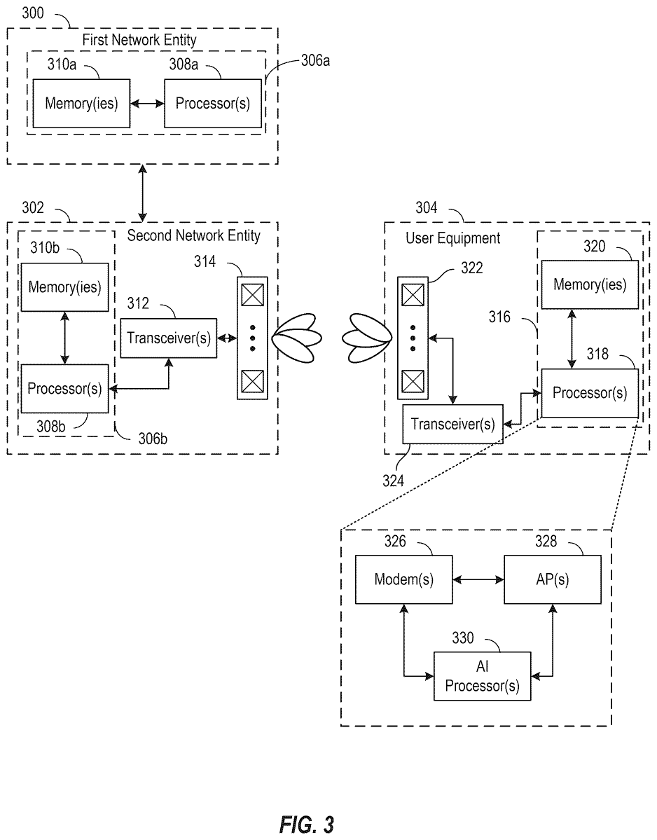

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

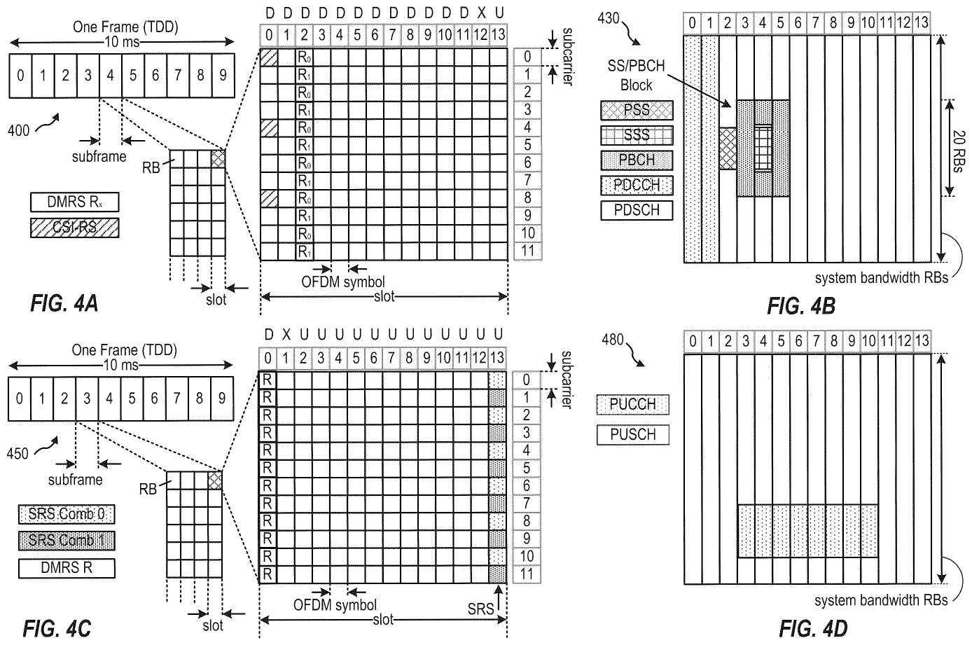

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example THP Structures

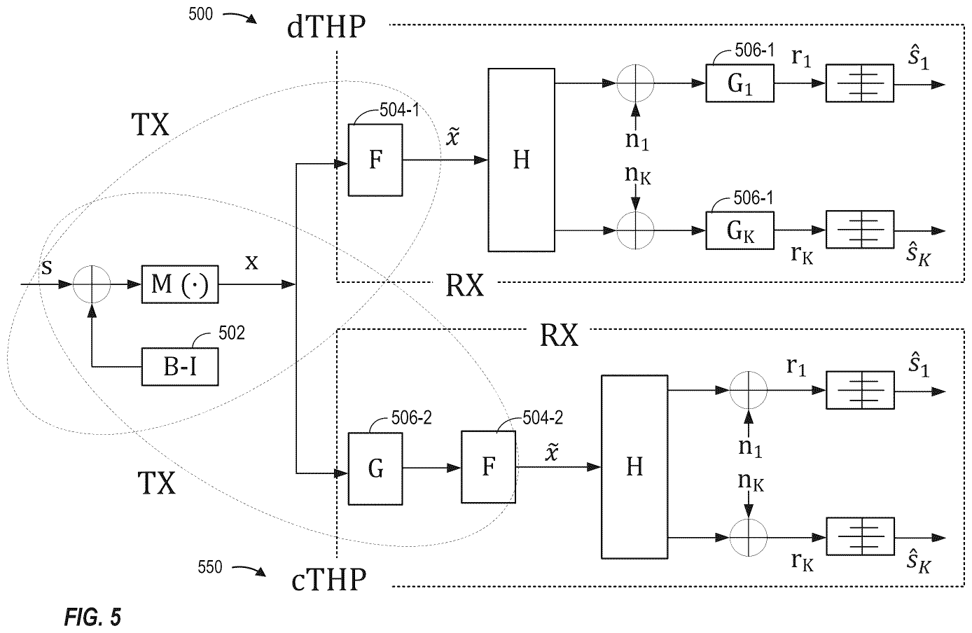

FIG. 5 depicts two example THP structures that may be used for channel equalization (e.g., TX equalization) at a transmitter. The THP structures may include a dTHP structure 500 and a cTHP structure 550.

As shown in FIG. 5, dTHP structure 500 may implement three filters, namely a feedback filter B 502 (shown as “B-I,” where the “I” refers to an identity matrix), a feedforward filter F 504-1, and a scaling filter G 506-1 (e.g., shown as G₁ to G_{K}). Similarly, cTHP structure 550 may implement three filters, including the feedback filter B 502, a feedforward filter F 504-2, and a scaling filter G 506-2. The feedback filter B 502 may be configured to handle multi-user interference by successively subtracting the interference from a current symbol. In certain aspects, the feedback filter B 502 may comprise a matrix having a lower triangular structure. A “lower triangular matrix” may refer to a matrix that includes zeros (0) at the upper right entries above a main diagonal of a matrix. For example, for a matrix A where Aᵢⱼ is the entry at the i^{th} row and the j^{th} column: Aᵢⱼ=0 ∀i<j.

The feedforward filter F 504-1, 504-2 may be configured to enforce spatial causality. Further, the scaling filter G 506-1, 506-2 may be configured to assign a coefficient or weight to each stream of data. In certain aspects, the scaling filter G 506-1, 506-2 may comprise a diagonal matrix. A “diagonal matrix” may refer to a matrix that includes zeros (0) at each entry, which is not at a diagonal of a matrix. For example, for a matrix A where Aᵢⱼ is the entry at the i^{th} row and the j^{th} column: Aᵢⱼ=0 ∀i≠j.

The main difference between dTHP structure 500 and cTHP structure 550 involves placement of the scaling filter G 506-1, 506-2. For example, the dTHP structure 500 may employ scaling filter G 506-1 (or sub-matrices of it) at a receiver (e.g., the RX side, shown outside of the dashed ellipse representing the TX side), such that the filter is “decentralized.” This is different from the cTHP structure 550 where scaling filter G 506-2 is employed at the transmitter (e.g., the TX side shown inside of the dashed ellipse), such that the filter is “centralized.”

As described above, employing the scaling filter G 506-2 at the transmitter, when using the cTHP structure 550, may result in the transmission power of a signal sent from the transmitter (e.g., to the receiver) to be different across different transmit antennas of the transmitter (e.g., one transmit antenna may transmit with higher power than another transmit antenna). Alternatively, employing the scaling filter G 506-1 at the receiver, when using the dTHP structure 500, may result in the receive power of a signal received by the receiver (e.g., sent from the transmitter) to be different across different receive antennas of the receiver (e.g., power for one receive antenna may higher than power for another receive antenna).

Because the cTHP structure 550 helps to achieve equal receive power across receive antennas, the receiver may need to perform only a single AGC operation for all receive antennas when using cTHP for TX equalization. The same may not be true when using dTHP, however. For example, when using the dTHP structure 500, the receiver may need to perform an AGC operation for each receive antenna separately given the variation in receive power across the receive antennas.

For example, a receiver may be configured to perform AGC to normalize the power of a received signal to a desired received power, where the desired receive power is determined based on hardware requirements of the receiver. During AGC operation, the receiver may measure the power of a received signal (e.g., generally based on the communication of pilot signal(s)). The receiver may then determine a multiplication factor (also referred to as a “normalization factor”) that, when applied to the measured power results in an appropriate power at the receiver (e.g., based on the receiver's hardware requirements). The receiver may multiply the received signal, at each receive antenna, by the same factor when the power of the received signal at each receive antenna is measured to be the same. However, when the receive power measured across receive antennas is different, a different multiplication factor may need to be determined and applied per receive antenna. In such cases, the receiver may need to instead perform AGC per receive antenna (and, in some cases, per precoding group in the case of selective channel). Performing AGC per receive antenna may necessitate the need for the estimation and correction of the received power per receive antenna, which necessitates a higher-complexity device.

As such, while the use of cTHP structure 550 may allow for communication with a lower complexity receiver, the use of dTHP structure 500 may necessitate that the communication is with a higher complexity receiver.

In certain aspects, the use of cTHP structure 550 for TX equalization may allow for communication with a lower complexity receiver, but at the cost of degraded transmission performance. Further, in certain aspects, the use of dTHP structure 500 for TX equalization may necessitate the need for a higher complexity receiver, but allow for improved transmission performance.

To allow for a tradeoff between complexity and transmission performance in different situations, it is beneficial for a transmitter and receiver to be capable of adapting a THP scheme used for TX equalization (e.g., such as dynamically switch between the use of the cTHP structure 550 and the dTHP structure 500).

### Aspects Related to THP Adaptation for TX Equalization

Aspects described herein improve upon the state of the art by providing signaling mechanisms that enable a transmitter to (1) dynamically select between suitable methods for TX equalization according to variable conditions and (2) configure a receiver to use the selected method. In certain aspects, the transmitter may select between the use of cTHP, dTHP, and/or both (e.g., for different resources) for performing TX equalization when communicating with a receiver.

In certain aspects, a receiver may send, to a transmitter, an indication of a capability of the receiver to use dTHP. The indication may indicate that the receiver supports dTHP or that the receiver does not support dTHP (e.g., by indicating that the receiver supports cTHP only). Based on receiving this capability information from the receiver, the transmitter may configure the receiver to use cTHP, dTHP, and/or both for receiving transmission(s) from the transmitter. The receiver may act in accordance with the configuration received from the transmitter. For example, the receiver may use cTHP, dTHP (e.g., performing AGC for each receive antenna element of the receiver), or both for receiving transmission(s) from the UE. In certain aspects, the use of cTHP and/or dTHP may help to mitigate the effects of distortion caused by a wireless communications channel used for communicating the transmission(s) between the transmitter and the receiver.

In certain aspects, such as for downlink communications, the transmitter may comprise a network entity, and the receiver may comprise a UE. In certain aspects, the network entity may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of UE 104 depicted and described with respect to FIG. 1 or the UE 304 depicted and described with respect to FIG. 3.

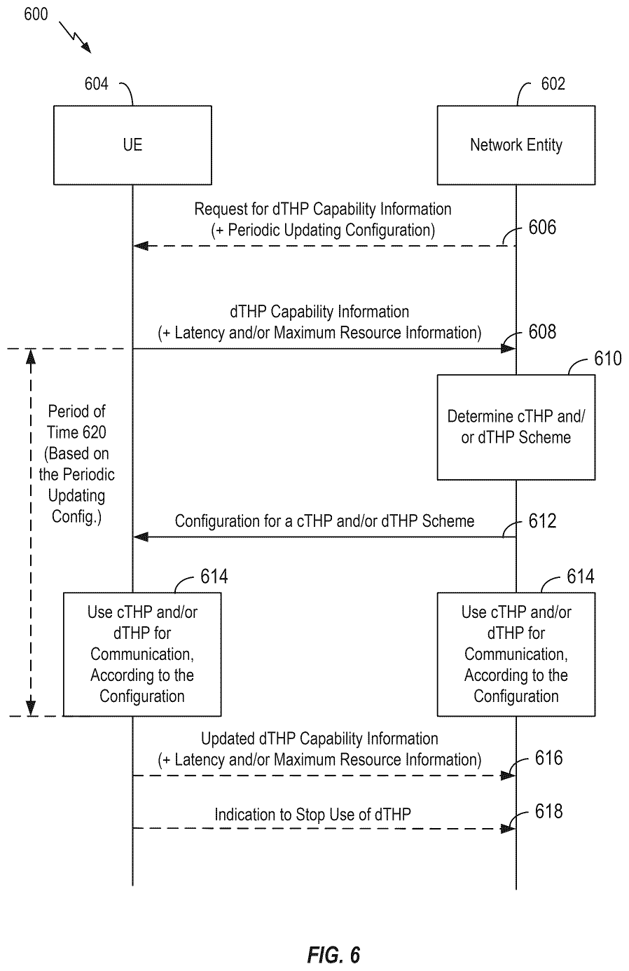

Additional details related to the signaling mechanisms described herein, which allow for channel equalization operation adaptation, such as THP adaptation, are provided below with respect to FIG. 6.

### Example Signaling for THP Adaptation

FIG. 6 depicts a process flow 600 for communications in a network between a network entity 602 and a UE 604. In certain aspects, the network entity 602 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 604 may be an example of UE 104 depicted and described with respect to FIG. 1 or the UE 304 depicted and described with respect to FIG. 3. However, in other aspects, UE 604 may be another type of wireless communications device and network entity 602 may be another type of network entity or network node, such as those described herein. Note that any operations or signaling illustrated with dashed lines may indicate that that operation or signaling is an optional or alternative example.

In certain aspects, process flow 600 of FIG. 6 may be used to adapt a THP operation used for TX equalization in downlink communications. For example, process flow 600 may be used to dynamically switch between the use of cTHP and/or dTHP for TX equalization to compensate for alteration(s) that signal(s) (e.g., downlink signal(s) may encounter when communicated between network entity 602 and UE 604.

Process flow 600 begins, at 608, with UE 604 sending, to network entity 602, dTHP capability information for UE 604. For example, at 608, UE 604 sends, to network entity 602, an indication of a capability of UE 604 to use dTHP. In certain aspects, the indication may inform network entity 602 that UE 604 supports the use of dTHP. UE 604 may support the use of dTHP where UE 604 is capable of performing AGC for each receive antenna of UE 604. UE 604 may be capable of performing AGC for each receive antenna where UE 604 is designed with advanced capabilities and/or features for performing this operation per receive antenna (e.g., UE 604 is not a limited complexity device).

In other aspects, the indication may inform network entity 602 that UE 604 does not support the use of dTHP (e.g., UE 604 is not capable of performing AGC for each receive antenna of UE 604). In certain aspects, the indication that UE 604 does not support the use of dTHP may be conveyed to network entity 602 based on UE 604 indicating a capability of UE 604 to use only cTHP.

In certain aspects, as described above, the dTHP capability information, sent by UE 604 to network entity 602 at 608, includes only a binary indication as to whether or not UE 604 supports the use of dTHP. For example, the dTHP capability information may include a bit of “0” indicating that the UE does not support the use of dTHP or include a bit of “1” indicating that the UE does support the use of dTHP. In certain other aspects, however, the dTHP capability information may include additional information.

For example, in some cases where the dTHP capability information indicates that UE 604 supports the use of dTHP, the dTHP capability information may further include latency information associated with the use of dTHP by UE 604. The latency information may indicate the additional latency that may occur as a result of UE 604 needing to perform AGC per receive antenna when dTHP is used for TX equalization.

As another example, in some cases where the dTHP capability information indicates that UE 604 supports the use of dTHP, the dTHP capability information may further indicate a maximum number of resources where UE 604 supports the use of dTHP. Put differently, UE 604 may indicate, via the dTHP capability information, a maximum number of resources (e.g., such as a maximum number of resource elements (REs), a maximum number of symbols, or a maximum number of slots) where UE 604 can afford the added complexity (e.g., perform AGC) required when using dTHP for TX equalization.

UE 604 may include the information about latency and/or the maximum number of resources such that network entity 602 takes this information into account when selecting the THP method to use for TX equalization (e.g., when selecting between the use of cTHP only, dTHP only, or both cTHP and dTHP).

In certain aspects, such as prior to transmission, at 608, of the dTHP capability information for UE 604, network entity 602 may send, to UE 604, a request to indicate its dTHP capability information. For example, the request may ask UE 604 to indicate its capability to use dTHP. In certain aspects, UE 604 may send the dTHP capability information to network entity 602, at 608, based on receiving the request from network entity 602.

In certain aspects, the request optionally sent at 606, from network entity 602 to UE 604, includes a periodic updating configuration. The periodic updating configuration, included in the request, may trigger UE 604 to provide periodic updates regarding a capability of UE 604 to use dTHP. More specifically, the periodic updating configuration may indicate a period of time 620 that may pass before UE 604 is expected to again indicate, to network entity 602, its dTHP capability information. Network entity 602 may include the periodic updating configuration in its request in order to receive periodic updates regarding the dTHP capability of UE 604, such that the THP used for TX equalization may be adapted as needed (e.g., adapted for different situations).

For example, as shown in FIG. 6, the request for dTHP capability information, sent at 606 from network entity 602 to UE 604, may include a periodic updating configuration indicating a period of time 620. Thus, after the period of time 620 has passed following the transmission of the dTHP capability information for UE 604 at 608, UE 604 may provide network entity 602 with updated dTHP capability information for UE 604. For example, at 616, UE 604 sends, to network entity 606, its updated dTHP capability information. In certain aspects, the updated dTHP capability information for UE 604 may be different than the dTHP capability information for UE 604 that was conveyed to network entity 602 at 608. In certain aspects, the updated dTHP capability information for UE 604 may be the same as the dTHP capability information for UE 604 that was conveyed to network entity 602 at 608.

Process flow 600 then proceeds, at block 610, with network entity 602 determining whether to use cTHP and/or dTHP for TX equalization. In certain aspects, network entity 602 may determine to use only cTHP for TX equalization. In certain aspects, network entity 602 may determine to use only dTHP for TX equalization. In certain aspects, network entity 602 may determine to use both cTHP and dTHP for TX equalization. For example, network entity 602 may determine to use cTHP for the transmission of a first set of signals on a first set of resources and use dTHP for the transmission of a second set of signals on a second set of resources.

In certain aspects, network entity 602 makes this determination at block 610 based on the dTHP capability information sent to network entity 602, from UE 604, at 608. For example, where the dTHP capability information indicates that UE 604 supports the use of dTHP, network entity 602 may determine to use (1) dTHP only or (2) cTHP and dTHP for TX equalization. As another example, where the dTHP capability information indicates that UE 604 does not support the use of dTHP, network entity 602 may determine to use cTHP only for TX equalization.

In certain aspects where the dTHP capability information includes the latency information and/or the maximum number of resources information, described in detail above, network entity 602 may further take such information into account when determining, at 610, which THP operation to use for TX equalization. As an illustrative example, the dTHP capability information sent, from UE 604 to network entity 602 at 608, may indicate that UE 604 supports the use of dTHP for N number of resources. Taking this information into consideration, at 610, network entity 602 may determine to use both cTHP and dTHP for TX equalization. More specifically, network entity 602 may determine to use dTHP for the transmission of a first set of signals on a first set of resources, where the first set of resources include N or less resources. Additionally, network entity 602 may determine to use cTHP for the transmission of a second set of signals on a second set of resources. In this example, the second set of resources (e.g., where cTHP is used) may include more problematic resources than the first set of resources (e.g., where dTHP is used) (e.g., put differently, more problematic resources may be configured with cTHP to save complexity at UE 604, and less problematic resources may be configured with dTHP). As used herein, “more problematic resources” (e.g., more problematic REs) may refer to resources that are experiencing fading. Thus, UE 604 may need to dedicate more power to the “more problematic resources,” for example, when using dTHP. This means that “more problematic resources” may result in more power consumption (and, in some cases, call for greater complexity) at UE 604.

Process flow 600 then proceeds, at 612, with network entity 602 sending, to UE 604, a configuration for performing TX equalization. In certain aspects, the configuration may indicate, to UE 604, to use cTHP to receive signal(s) from network entity 602 (e.g., such as on a first set of resources). In certain aspects, the configuration may indicate, to UE 604, to use dTHP to receive signal(s) from network entity 602 (e.g., such as on the first set of resources). In certain aspects, the configuration may indicate, to UE 604, to use cTHP and dTHP to receive signal(s) from network entity 602. For example, the configuration may indicate to use cTHP to receive signal(s) on a second set of resources and use dTHP to receive signal(s) on a third set of resources. The second set of resources and the third set of resource may be different. In certain aspects, the second set of resources and the third set of resources may together make up resources included in the first set of resources.

At 614, network entity 602 and UE 604 may communicate according to the configuration. For example, network entity 602 and UE 604 may use cTHP and/or dTHP for TX equalization (e.g., based on the configuration).

In some cases after UE 604 is configured to use dTHP for TX equalization (e.g., via the configuration sent to UE 604 at 612), UE 604 may determine that it no longer supports the use of dTHP. As such, UE 604 may send, to network entity 602 at 618, an indication to stop use of the dTHP. Put differently, UE 604 may send, at 618, an aperiodic request to stop use of an AGC mechanism at UE 604 for each receive antenna of UE 604. In certain aspects, UE 604 may send the indication to stop use of dTHP/its AGC mechanism to help save power at UE 604 (e.g., such as due to a low battery of UE 604).

Additionally, in some cases (although not shown in FIG. 6), after requesting to deactivate the use of dTHP at UE 604, UE 604 may send, to network entity 602, a request to re-activate the use of dTHP (e.g., such as when the battery power of UE 604 is again determined to be efficient for performing AGC per receive antenna).

Note that the process flow 600 illustrated in FIG. 6 is described herein to facilitate an understanding of THP adaptation, and aspects of the present disclosure may be performed in various manners via alternative or additional signaling and/or operations. In certain aspects, the operations and/or signaling of FIG. 6 may occur in an order different from that described or depicted, and various actions, operations, and/or signaling may be added, omitted, or combined.

Although FIG. 6 describes network entity 602 (e.g., the transmitter) determining which THP operation to use for TX equalization based on information and/or request(s) from UE 604 (e.g., the receiver), in some other examples, network entity 602 may determine which THP operation to use for TX equalization based on its own policy and/or requirements.

### Example Operations of a User Equipment

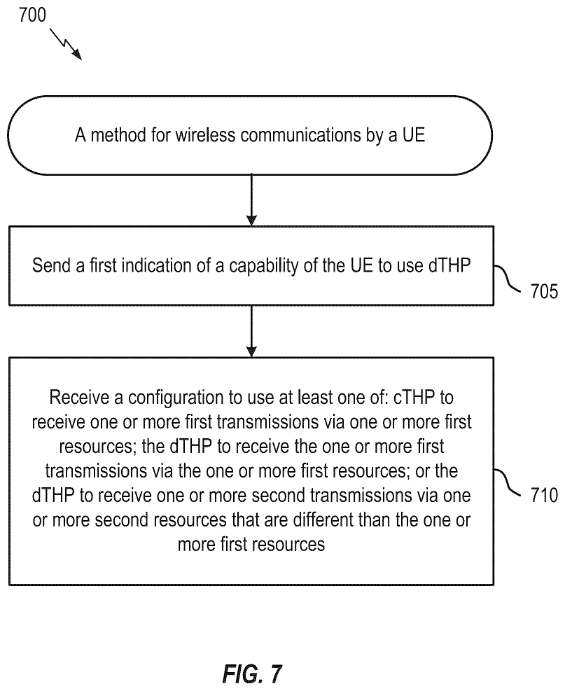

FIG. 7 shows a method 700 for wireless communications by an apparatus, such as UE 104 of FIG. 1 or UE 304 of FIG. 3.

Method 700 begins at block 705 with sending a first indication of a capability of the UE to use dTHP.

Method 700 then proceeds to block 710 with receiving a configuration to use at least one of: cTHP to receive one or more first transmissions via one or more first resources; the dTHP to receive the one or more first transmissions via the one or more first resources; or the dTHP to receive one or more second transmissions via one or more second resources that are different than the one or more first resources.

In some aspects, the first indication of the capability of the UE to use the dTHP comprises an indication of the capability of the UE to perform automatic gain control for each receive antenna of the UE.

In some aspects, method 700 further includes receiving a request to indicate the capability of the UE to use the dTHP, and block 705 includes sending the first indication of the capability of the dTHP based on the request.

In some aspects, the request comprises a periodic updating configuration, the method 700 further comprises sending a second indication of the capability of the UE to use the dTHP a period of time after sending the first indication, and the period of time is based on the periodic updating configuration.

In some aspects, receiving the request comprises receiving the request via a MAC-CE.

In some aspects, receiving the request comprises receiving the request via RRC signaling.

In some aspects, the first indication of the capability of the UE to use the dTHP indicates that the UE supports the use of the dTHP.

In some aspects, the configuration is to use the dTHP to receive the one or more first transmissions via the one or more first resources or the one or more second resources.

In some aspects, the configuration is to use: the cTHP to receive the one or more first transmissions via the one or more first resources; and the dTHP to receive the one or more first transmissions via the one or more second resources.

In some aspects, the first indication of the capability of the UE to use the dTHP further indicates a latency associated with use of the dTHP by the UE.

In some aspects, the first indication of the capability of the UE to use the dTHP further indicates a maximum number of resources where the UE supports the use of the dTHP.

In some aspects, the maximum number of resources comprises: a maximum number of REs; a maximum number of symbols; or a maximum number of slots.

In some aspects, the configuration is to use: the dTHP to receive the one or more first transmissions via the one or more first resources; or the cTHP to receive the one or more first transmissions via the one or more first resources and the dTHP to receive the one or more first transmissions via the one or more second resources, and the method 700 further comprises sending, to a network entity in response to receiving the configuration, a request to stop the use of the dTHP to receive the one or more first transmissions.

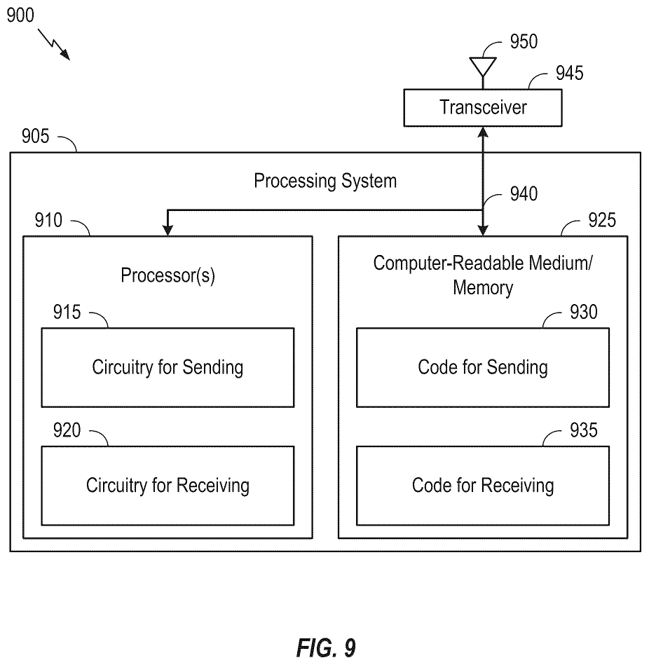

In some aspects, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative operations are possible consistent with this disclosure.

### Example Operations of a Network Entity

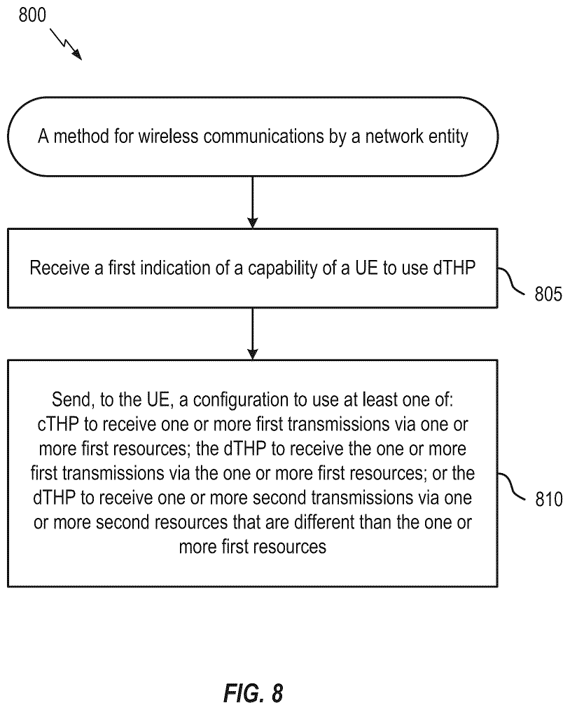

FIG. 8 shows a method 800 for wireless communications by an apparatus, such as BS 102 of FIG. 1, a first network entity 300 or second network entity 302 of FIG. 3, or a disaggregated base station as discussed with respect to FIG. 2.

Method 800 begins at block 805 with receiving a first indication of a capability of a UE to use dTHP.

Method 800 then proceeds to block 810 with sending, to the UE, a configuration to use at least one of: cTHP to receive one or more first transmissions via one or more first resources; the dTHP to receive the one or more first transmissions via the one or more first resources; or the dTHP to receive one or more second transmissions via one or more second resources that are different than the one or more first resources.

In some aspects, the first indication of the capability of the UE to use the dTHP comprises an indication of the capability of the UE to perform automatic gain control for each receive antenna of the UE.

In certain aspects, method 800 further includes sending a request to indicate the capability of the UE to use the dTHP, and block 805 includes receiving the first indication of the capability of the dTHP based on the request.

In some aspects, the request comprises a periodic updating configuration, the method 800 further comprises sending a second indication of the capability of the UE to use the dTHP a period of time after sending the first indication, and the period of time is based on the periodic updating configuration.

In some aspects, sending the request comprises sending the request via a MAC-CE.

In some aspects, sending the request comprises sending the request via RRC signaling.

In some aspects, the first indication of the capability of the UE to use the dTHP indicates that the UE supports the use of the dTHP.

In some aspects, the configuration is to use the dTHP to receive the one or more first transmissions via the one or more first resources or the one or more second resources.

In some aspects, the configuration is to use: the cTHP to receive the one or more first transmissions via the one or more first resources; and the dTHP to receive the one or more first transmissions via the one or more second resources.

In some aspects, the first indication of the capability of the UE to use the dTHP further indicates a latency associated with use of the dTHP by the UE; and the method 800 further comprises determining at least one of the one or more first resources or the one or more second resources based on the latency.

In some aspects, the first indication of the capability of the UE to use the dTHP further indicates a maximum number of resources where the UE supports the use of the dTHP; and the method 800 further comprises determining at least one of the one or more first resources or the one or more second resources based on the maximum number of resources.

In some aspects, the maximum number of resources comprises: a maximum number of REs; a maximum number of symbols; or a maximum number of slots.

In some aspects, the configuration is to use: the dTHP to receive the one or more first transmissions via the one or more first resources; or the cTHP to receive the one or more first transmissions via the one or more first resources and the dTHP to receive the one or more first transmissions via the one or more second resources, and the method 800 further comprises receiving, from the UE in response to sending the configuration, a request to stop the use of the dTHP to receive the one or more first transmissions.

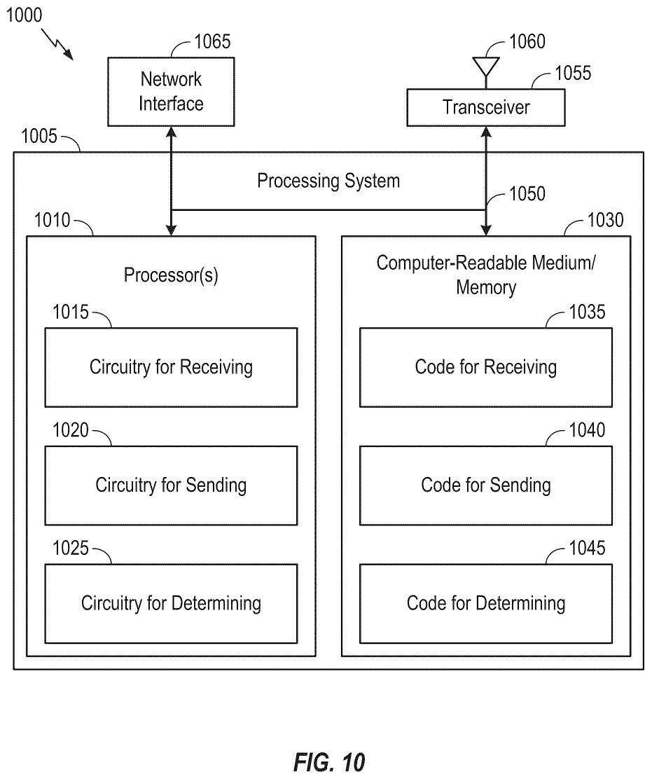

In some aspects, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

### Example Communications Devices

FIG. 9 depicts aspects of an example communications device 900 configured for wireless communications. In some aspects, communications device 900 is a user equipment, such as UE 104 described above with respect to FIG. 1 or UE 304 described with respect to FIG. 3.

The communications device 900 includes a processing system 905 coupled to a transceiver 945 (e.g., a transmitter and/or a receiver). The transceiver 945 is configured to transmit and receive signals for the communications device 900 via an antenna 950, such as the various signals as described herein. The processing system 905 may be configured to perform processing functions for the communications device 900, including processing signals received and/or to be transmitted by the communications device 900.

The processing system 905 includes one or more processors 910 and a computer-readable medium/memory 925. In various aspects, the one or more processors 910 may be representative of the one or more processors 318 described with respect to FIG. 3. The one or more processors 910 are coupled to a computer-readable medium/memory 925 via a bus 940. In some aspects, the computer-readable medium/memory 925 may be representative of the one or more memories 320 described with respect to FIG. 3. The computer-readable medium/memory 925 is a non-transitory computer-readable medium/memory. In certain aspects, the computer-readable medium/memory 925 is configured to store instructions (e.g., computer-executable code), that when executed by the one or more processors 910, cause the one or more processors 910 to perform the method 700 described with respect to FIG. 7, or any aspect related to it, including any operations described in relation to FIG. 7. Note that reference to a processor performing a function of communications device 900 may include one or more processors performing that function of communications device 900, such as in a distributed fashion.

In the depicted example, computer-readable medium/memory 925 stores code (e.g., executable instructions), including code for sending 930 and code for receiving 935. Processing of the code for sending 930 and the code for receiving 935 may enable and cause the communications device 900 to perform the method 700 described with respect to FIG. 7, or any aspect related to it. For instance, in some aspects, code for sending 930 includes code for sending a first indication of a capability of the UE to use dTHP. In some aspects, code for receiving 935 includes code for receiving a configuration to use at least one of: cTHP to receive one or more first transmissions via one or more first resources; the dTHP to receive the one or more first transmissions via the one or more first resources; or the dTHP to receive one or more second transmissions via one or more second resources that are different than the one or more first resources.

The one or more processors 910 include circuitry configured to implement (e.g., execute) the code stored in the computer-readable medium/memory 925, including circuitry for sending 915 and circuitry for receiving 920. Processing with circuitry for sending 915 and the circuitry for receiving 920 may enable and cause the communications device 900 to perform the method 700 described with respect to FIG. 7, or any aspect related to it. For instance, in some aspects, circuitry for sending 915 includes circuitry for sending a first indication of a capability of the UE to use dTHP. In some aspects, circuitry for receiving 920 includes circuitry for receiving a configuration to use at least one of: cTHP to receive one or more first transmissions via one or more first resources; the dTHP to receive the one or more first transmissions via the one or more first resources; or the dTHP to receive one or more second transmissions via one or more second resources that are different than the one or more first resources.

More generally, means for communicating, transmitting, sending or outputting for transmission may include the one or more transceivers 324, one or more antenna 322 and/or processing system 316 of the UE 304 illustrated in FIG. 3, transceiver 945 and/or antenna 950 of the communications device 900 in FIG. 9, and/or one or more processors 910 of the communications device 900 in FIG. 9. Means for communicating, receiving or obtaining may include the one or more transceivers 324, one or more antennas 322, and/or processing system 316 of the UE 304 illustrated in FIG. 3, transceiver 945 and/or antenna 950 of the communications device 900 in FIG. 9, and/or one or more processors 910 of the communications device 900 in FIG. 9.

FIG. 10 depicts aspects of an example communications device configured for wireless communications. In some aspects, communications device 1000 is a network entity, such as BS 102 of FIG. 1, first network entity 300 or second network entity 302 of FIG. 3, or a disaggregated base station as discussed with respect to FIG. 2.

The communications device 1000 includes a processing system 1005 coupled to a transceiver 1055 (e.g., a transmitter and/or a receiver) and/or a network interface 1065. The transceiver 1055 is configured to transmit and receive signals for the communications device 1000 via an antenna 1060, such as the various signals as described herein. The network interface 1065 is configured to obtain and send signals for the communications device 1000 via communications link(s), such as a backhaul link, midhaul link, and/or fronthaul link as described herein, such as with respect to FIG. 2. The processing system 1005 may be configured to perform processing functions for the communications device 1000, including processing signals received and/or to be transmitted by the communications device 1000.

The processing system 1005 includes one or more processors 1010 and a computer-readable medium/memory 1030. In various aspects, one or more processors 1010 may be representative of the one or more processors 308, as described with respect to FIG. 3. The one or more processors 1010 are coupled to the computer-readable medium/memory 1030 via a bus 1050. In certain aspects, the computer-readable medium/memory 1030 is configured to store instructions (e.g., computer-executable code), including code 1035-1045, that when executed by the one or more processors 1010, cause the one or more processors 1010 to perform the method 800 described with respect to FIG. 8, or any aspect related to it, including any operations described in relation to FIG. 8. The computer-readable medium/memory 1030 is a non-transitory computer-readable medium/memory. Note that reference to a processor of communications device 1000 performing a function may include one or more processors of communications device 1000 performing that function, such as in a distributed fashion.

In the depicted example, the computer-readable medium/memory 1030 stores code (e.g., executable instructions), including code for receiving 1035, code for sending 1040, and code for determining 1045. Processing of the code 1035-1045 may enable and cause the communications device 1000 to perform the method 800 described with respect to FIG. 8, or any aspect related to it. For instance, in some aspects, code for receiving 1035 includes code for receiving a first indication of a capability of a UE to use dTHP. In some aspects, code for sending 1040 include code for sending, to the UE, a configuration to use at least one of: cTHP to receive one or more first transmissions via one or more first resources; the dTHP to receive the one or more first transmissions via the one or more first resources; or the dTHP to receive one or more second transmissions via one or more second resources that are different than the one or more first resources.

The one or more processors 1010 include circuitry configured to implement (e.g., execute) the code stored in the computer-readable medium/memory 1030, including circuitry for receiving 1015, circuitry for sending 1020, and circuitry for determining 1025. Processing with circuitry 1015-1025 may enable and cause the communications device 1000 to perform the method 800 described with respect to FIG. 8, or any aspect related to it. For instance, in some aspects, circuitry for receiving 1015 includes circuitry for receiving a first indication of a capability of a UE to use dTHP. In some aspects, circuitry for sending 1020 include circuitry for sending, to the UE, a configuration to use at least one of: cTHP to receive one or more first transmissions via one or more first resources; the dTHP to receive the one or more first transmissions via the one or more first resources; or the dTHP to receive one or more second transmissions via one or more second resources that are different than the one or more first resources.

Various components of the communications device 1000 may provide means for performing the method 800 described with respect to FIG. 8, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1055, antenna 1060, and/or network interface 1065 of the communications device 1000 in FIG. 10, and/or one or more processors 1010 of the communications device 1000 in FIG. 10. Means for communicating, receiving or obtaining may include the one or more transceivers 312, one or more antennas 314, and/or processing system 306 of the first network entity 300 or the second network entity 302 illustrated in FIG. 3, transceiver 1055, antenna 1060, and/or network interface 1065 of the communications device 1000 in FIG. 10, and/or one or more processors 1010 of the communications device 1000 in FIG. 10.

### Example Clauses

Implementation examples are described in the following numbered clauses:
Clause 1: A method for wireless communications by a UE comprising: sending a first indication of a capability of the UE to use dTHP; and receiving a configuration to use at least one of: cTHP to receive one or more first transmissions via one or more first resources; the dTHP to receive the one or more first transmissions via the one or more first resources; or the dTHP to receive one or more second transmissions via one or more second resources that are different than the one or more first resources.
Clause 2: The method of Clause 1, wherein the first indication of the capability of the UE to use the dTHP comprises an indication of the capability of the UE to perform automatic gain control for each receive antenna of the UE.
Clause 3: The method of any one of Clauses 1-2, further comprising receiving a request to indicate the capability of the UE to use the dTHP, and sending the first indication comprises sending the first indication of the capability of the dTHP based on the request.
Clause 4: The method of Clause 3, wherein: the request comprises a periodic updating configuration, the method further comprises sending a second indication of the capability of the UE to use the dTHP a period of time after sending the first indication, and the period of time is based on the periodic updating configuration.
Clause 5: The method of Clause 3, wherein receiving the request comprises receiving the request via a MAC-CE.
Clause 6: The method of Clause 3, wherein receiving the request comprises receiving the request via RRC signaling.
Clause 7: The method of any one of Clauses 1-6, wherein the first indication of the capability of the UE to use the dTHP indicates that the UE supports the use of the dTHP.
Clause 8: The method of Clause 7, wherein the configuration is to use the dTHP to receive the one or more first transmissions via the one or more first resources or the one or more second resources.
Clause 9: The method of Clause 7, wherein the configuration is to use: the cTHP to receive the one or more first transmissions via the one or more first resources; and the dTHP to receive the one or more first transmissions via the one or more second resources.
Clause 10: The method of Clause 7, wherein: the first indication of the capability of the UE to use the dTHP further indicates a latency associated with use of the dTHP by the UE.
Clause 11: The method of Clause 7, wherein: the first indication of the capability of the UE to use the dTHP further indicates a maximum number of resources where the UE supports the use of the dTHP.
Clause 12: The method of Clause 11, wherein the maximum number of resources comprises: a maximum number of REs; a maximum number of symbols; or a maximum number of slots.
Clause 13: The method of Clause 7, wherein: the configuration is to use: the dTHP to receive the one or more first transmissions via the one or more first resources; or the cTHP to receive the one or more first transmissions via the one or more first resources and the dTHP to receive the one or more first transmissions via the one or more second resources, and the method further comprises sending, to a network entity in response to receiving the configuration, a request to stop the use of the dTHP to receive the one or more first transmissions.
Clause 14: A method for wireless communications by a network entity comprising: receiving a first indication of a capability of a UE to use dTHP; and sending, to the UE, a configuration to use at least one of: cTHP to receive one or more first transmissions via one or more first resources; the dTHP to receive the one or more first transmissions via the one or more first resources; or the dTHP to receive one or more second transmissions via one or more second resources that are different than the one or more first resources.
Clause 15: The method of Clause 14, wherein the first indication of the capability of the UE to use the dTHP comprises an indication of the capability of the UE to perform automatic gain control for each receive antenna of the UE.
Clause 16: The method of any one of Clauses 14-15, further comprising sending a request to indicate the capability of the UE to use the dTHP, and receiving the first indication comprises receiving the first indication of the capability of the dTHP based on the request.
Clause 17: The method of Clause 16, wherein: the request comprises a periodic updating configuration, the method further comprises sending a second indication of the capability of the UE to use the dTHP a period of time after sending the first indication, and the period of time is based on the periodic updating configuration.
Clause 18: The method of Clause 16, wherein sending the request comprises sending the request via a MAC-CE.
Clause 19: The method of Clause 16, wherein sending the request comprises sending the request via RRC signaling.
Clause 20: The method of any one of Clauses 14-19, wherein the first indication of the capability of the UE to use the dTHP indicates that the UE supports the use of the dTHP.
Clause 21: The method of Clause 20, wherein the configuration is to use the dTHP to receive the one or more first transmissions via the one or more first resources or the one or more second resources.
Clause 22: The method of Clause 20, wherein the configuration is to use: the cTHP to receive the one or more first transmissions via the one or more first resources; and the dTHP to receive the one or more first transmissions via the one or more second resources.
Clause 23: The method of Clause 20, wherein: the first indication of the capability of the UE to use the dTHP further indicates a latency associated with use of the dTHP by the UE; and the method further comprises determining at least one of the one or more first resources or the one or more second resources based on the latency.
Clause 24: The method of Clause 20, wherein: the first indication of the capability of the UE to use the dTHP further indicates a maximum number of resources where the UE supports the use of the dTHP; and the method further comprises determining at least one of the one or more first resources or the one or more second resources based on the maximum number of resources.
Clause 25: The method of Clause 24, wherein the maximum number of resources comprises: a maximum number of REs; a maximum number of symbols; or a maximum number of slots.
Clause 26: The method of Clause 20, wherein: the configuration is to use: the dTHP to receive the one or more first transmissions via the one or more first resources; or the cTHP to receive the one or more first transmissions via the one or more first resources and the dTHP to receive the one or more first transmissions via the one or more second resources, and the method further comprises receiving, from the UE in response to sending the configuration, a request to stop the use of the dTHP to receive the one or more first transmissions.
Clause 27: One or more apparatuses, comprising: one or more memories comprising executable instructions; and one or more processors configured to execute the executable instructions and cause the one or more apparatuses to perform a method in accordance with any one of Clauses 1-26.
Clause 28: One or more apparatuses configured for wireless communications, comprising: one or more memories; and one or more processors, coupled to the one or more memories, configured to cause the one or more apparatuses to perform a method in accordance with any one of Clauses 1-26.
Clause 29: One or more apparatuses configured for wireless communications, comprising: one or more memories; and one or more processors, coupled to the one or more memories, configured to perform a method in accordance with any one of Clauses 1-26.
Clause 30: One or more apparatuses, comprising means for performing a method in accordance with any one of Clauses 1-26.
Clause 31: One or more non-transitory computer-readable media comprising executable instructions that, when executed by one or more processors of one or more apparatuses, cause the one or more apparatuses to perform a method in accordance with any one of Clauses 1-26.
Clause 32: One or more computer program products embodied on one or more computer-readable storage media comprising code for performing a method in accordance with any one of Clauses 1-26.
Clause 33: One or more apparatuses configured for wireless communications, comprising: a processing system that includes one or more processors and one or more memories coupled with the one or more processors, the processing system configured to cause the one or more apparatuses to perform a method in accordance with any one of Clauses 1-26.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
send a first indication of a capability of the UE to use decentralized Tomlinson-Harashima Precoding (dTHP); and
receive a configuration to use at least one of:
centralized Tomlinson-Harashima Precoding (cTHP) to receive one or more first transmissions via one or more first resources;
the dTHP to receive the one or more first transmissions via the one or more first resources; or
the dTHP to receive one or more second transmissions via one or more second resources that are different than the one or more first resources.

2. The apparatus of claim 1, wherein the first indication of the capability of the UE to use the dTHP comprises an indication of the capability of the UE to perform automatic gain control for each receive antenna of the UE.

3. The apparatus of claim 1, wherein:
the processing system is configured to cause the UE to receive a request to indicate the capability of the UE to use the dTHP, and
in order to cause the UE to send the first indication, the processing system is configured to cause the UE to send the first indication of the capability of the dTHP based on the request.

4. The apparatus of claim 3, wherein:
the request comprises a periodic updating configuration,
the processing system is configured to cause the UE to send a second indication of the capability of the UE to use the dTHP a period of time after sending the first indication, and
the period of time is based on the periodic updating configuration.

5. The apparatus of claim 1, wherein the first indication of the capability of the UE to use the dTHP indicates that the UE supports the use of the dTHP.

6. The apparatus of claim 5, wherein the configuration is to use the dTHP to receive the one or more first transmissions via the one or more first resources or the one or more second resources.

7. The apparatus of claim 5, wherein the configuration is to use:
the cTHP to receive the one or more first transmissions via the one or more first resources; and
the dTHP to receive the one or more first transmissions via the one or more second resources.

8. The apparatus of claim 5, wherein:
the first indication of the capability of the UE to use the dTHP further indicates a latency associated with use of the dTHP by the UE.

9. The apparatus of claim 5, wherein:
the first indication of the capability of the UE to use the dTHP further indicates a maximum number of resources where the UE supports the use of the dTHP.

10. The apparatus of claim 5, wherein:
the configuration is to use:
the dTHP to receive the one or more first transmissions via the one or more first resources; or
the cTHP to receive the one or more first transmissions via the one or more first resources and the dTHP to receive the one or more first transmissions via the one or more second resources, and
in response to receiving the configuration, the processing system is configured to cause the UE to send, to a network entity, a request to stop the use of the dTHP to receive the one or more first transmissions.

11. A method of wireless communications by a user equipment (UE), comprising:
sending a first indication of a capability of the UE to use decentralized Tomlinson-Harashima Precoding (dTHP); and
receiving a configuration to use at least one of:
centralized Tomlinson-Harashima Precoding (cTHP) to receive one or more first transmissions via one or more first resources;
the dTHP to receive the one or more first transmissions via the one or more first resources; or
the dTHP to receive one or more second transmissions via one or more second resources that are different than the one or more first resources.

12. The method of claim 11, wherein the first indication of the capability of the UE to use the dTHP comprises an indication of the capability of the UE to perform automatic gain control for each receive antenna of the UE.

13. The method of claim 11, further comprising:
receiving a request to indicate the capability of the UE to use the dTHP, wherein sending the first indication of the capability of the dTHP based on the request.

14. The method of claim 13, wherein:
the request comprises a periodic updating configuration,
the method further comprises sending a second indication of the capability of the UE to use the dTHP a period of time after sending the first indication, and
the period of time is based on the periodic updating configuration.

15. The method of claim 11, wherein the first indication of the capability of the UE to use the dTHP indicates that the UE supports the use of the dTHP.

16. The method of claim 15, wherein the configuration is to use the dTHP to receive the one or more first transmissions via the one or more first resources or the one or more second resources.

17. The method of claim 15, wherein the configuration is to use:
the cTHP to receive the one or more first transmissions via the one or more first resources; and
the dTHP to receive the one or more first transmissions via the one or more second resources.

18. The method of claim 15, wherein:
the first indication of the capability of the UE to use the dTHP further indicates a latency associated with use of the dTHP by the UE.

19. The method of claim 15, wherein:
the first indication of the capability of the UE to use the dTHP further indicates a maximum number of resources where the UE supports the use of the dTHP.

20. One or more non-transitory computer-readable media comprising executable instructions that, when executed by one or more processors of an apparatus, cause a user equipment (UE) to perform operations comprising:
sending a first indication of a capability of the UE to use decentralized Tomlinson-Harashima Precoding (dTHP); and
receiving a configuration to use at least one of:
centralized Tomlinson-Harashima Precoding (cTHP) to receive one or more first transmissions via one or more first resources;
the dTHP to receive the one or more first transmissions via the one or more first resources; or
the dTHP to receive one or more second transmissions via one or more second resources that are different than the one or more first resources.
